(19) United States
(12) Patent Application Publication
(10) Pub. No.: US 2025/0123884 A1
(43) Pub. Date: Apr. 17, 2025

(54) CONFIGURATOR TO GENERATE OPTIMIZED TASK-TO-RESOURCE ASSIGNMENT SOLUTION

(71) Applicant: INTERNATIONAL BUSINESS MACHINES CORPORATION, Armonk, NY (US)

(72) Inventors: Jian WU, Round Rock, TX (US); Cheranellore VASUDEVAN, Bastrop, TX (US); Sagar Krupa Satya KUNAVARAPU, Bengaluru (IN); Apparsamy PERUMAL, Bangalore (IN)

(21) Appl. No.: 18/485,362

(22) Filed: Oct. 12, 2023

(51) Int. Cl. G06F 9/48

(52) U.S. Cl. CPC G06F 9/4881

(57) ABSTRACT

Resource assignment optimization is provided by obtaining preferences and capabilities for resources to complete tasks of a job, and representing the tasks as sets of configurable items, including a set of unassigned tasks to be assigned, and a set of proposed task assignments identifying proposed task assignments to resources, including the preferences and capabilities of the resources. The optimization process further includes obtaining a configurator to execute on one or more processors to generate an optimized solution, which identifies for the unassigned tasks an optimal set of assigned tasks to resources obtained with reference to the set of proposed task assignments, and executing the configurator to automatically generate the optimized solution, where the optimized solution contains task-to-resource assignments based on the capabilities of the resources, while meeting a satisfaction goal for completion of the job based on the preferences of the resources.

### BACKGROUND

This disclosure relates generally to facilitating processing within a computing environment, and more particularly to facilitating generation of an optimized task-to-resource assignment solution for performing a job with multiple tasks.

By way of example, a resource to be assigned, such as a resource or component of a computing environment, can be physical or virtual, and typically have limited availability. In one embodiment, a resource can be any system component, and/or any connected device to a computer system. Within this context, a variety of approaches are available to facilitate managing resources to achieve performance of a job with multiple tasks. Typically, the resource management focuses on generating task-to-resource assignments which seek to efficiently perform the job by, for instance, minimizing use of resources and/or minimizing processing time.

As another example, a software development project can use multiple resources, such as software developers and computing resources, with different resources having different skills, and in the case of software developers, different interests. In a typical agile methodology, there is an assumption that most resources are skilled to do many different tasks. Another assumption is that there are certain tasks which are not divisible, or shareable, which means that those tasks are to be performed by only one resource. Further, there can be other tasks that can be shared across one or more resources. Within this context, task-to-resource assignments are again typically made to optimize efficiency and minimize costs in performing the job.

### SUMMARY

Certain shortcomings of the prior art are overcome, and additional advantages are provided herein through the provision of a computer-implemented method which includes obtaining, by one or more processors, preferences and capabilities for resources to complete tasks of a job, and representing the tasks as sets of configurable items. The sets of configurable items include a set of unassigned tasks identifying the tasks of the job to be assigned to the resources, and a set of proposed task assignments identifying one or more tasks of the job with proposed assignments to one or more of the resources, and with preferences and capabilities of the one or more resources indicated for completing the one or more tasks. Further, the computer-implemented method includes obtaining a configurator to execute on the one or more processors to generate an optimized solution which identifies for the set of unassigned tasks an optimal set of assigned tasks to the resources based on possible combinations of task-to-resource assignments obtained, at least in part, with reference to the set of proposed task assignments, where the optimized solution contains task-to-resource assignments based, at least in part, on the capabilities of the resources, while meeting a satisfaction goal for completion of the job based, at least in part, on the preferences of the resources. In addition, the computer-implemented method includes executing the configurator on the one or more resources to automatically generate the optimized solution which identifies for the set of unassigned tasks the optimal set of assigned tasks to the resources, where the optimized solution contains task-to-resource assignments based, at least in part, on the capabilities of the resources, while meeting the satisfaction goal for completion of the job based, at least in part, on the preferences of the resources.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with a resource assignment optimization module, in accordance with one or more aspects of the present disclosure;

FIG. 3 depicts one embodiment of a resource assignment optimization process, in accordance with one or more aspects of the present disclosure;

FIG. 4 is a more detailed embodiment of a resource assignment optimization process, in accordance with one or more aspects of the present disclosure;

FIG. 5 illustrates one embodiment of a configurator to generate an optimized solution of task-to-resource assignments which meets a satisfaction goal for completion of a job, in accordance with one or more aspects of the present disclosure;

FIG. 6A depicts one embodiment of a development project schedule for which an optimized solution of task-to-resource assignments is to be configurator-generated, in accordance with one or more aspects of the present disclosure;

FIGS. 6B-6D illustrate availabilities with preferences and suitabilities of three different developer resources to potentially assist with the tasks of the development project, in accordance with one or more aspects of the present disclosure;

FIG. 7A depicts one embodiment of a set of unassigned tasks (UT) and a set of proposed task assignments (PT) obtained for use by a configurator in generating an optimized solution of task-to-resource assignments, in accordance with one or more aspects of the present disclosure;

FIG. 7B depicts the set of unassigned tasks (UT) and the set of proposed task assignments (PT) of FIG. 7A, after applying one or more constraints and/or priorities to the sets of configurable items, in accordance with one or more aspects of the present disclosure; and

FIG. 7C depicts the set of unassigned tasks (UT) and an exemplary selected set of assigned tasks (AT) which represents the optimized solution containing task-to-resource assignments based, at least in part, on the capabilities of the resources, while meeting a satisfaction goal for completion of the job based, at least in part, on preferences of the resources, in accordance with one or more aspects of the present disclosure.

### DETAILED DESCRIPTION

The accompanying figures, which are incorporated in and form a part of this specification, further illustrate the present disclosure and, together with this detailed description of the disclosure, serve to explain aspects of the present disclosure. Note in this regard that descriptions of well-known systems, devices, processing techniques, etc., are omitted so as to not unnecessarily obscure the disclosure in detail. It should be understood, however, that the detailed description and specific example(s), while indicating aspects of the disclosure, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative control embodiment can be implemented in software, hardware, or a combination thereof.

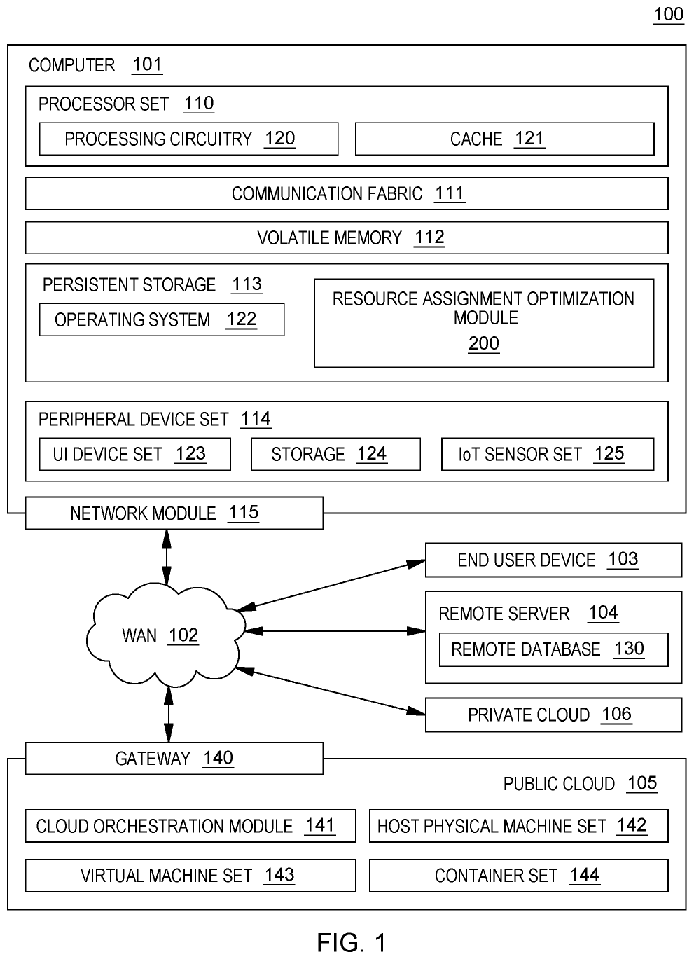

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and resource assignment optimization module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform resource assignment optimization processing, such as disclosed herein. Aspects of the present disclosure are not limited to a particular architecture or environment.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as resource assignment optimization module block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

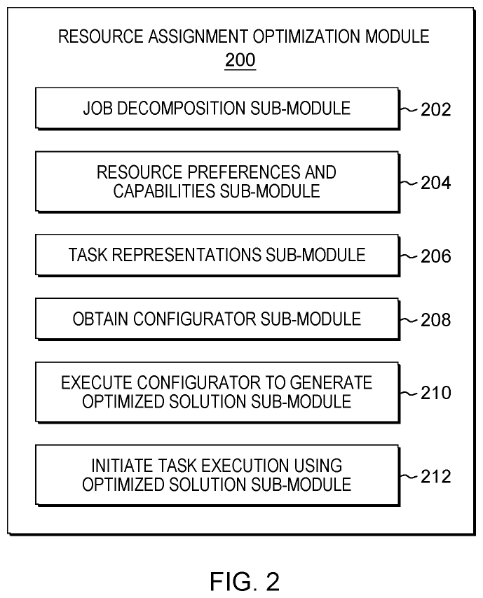

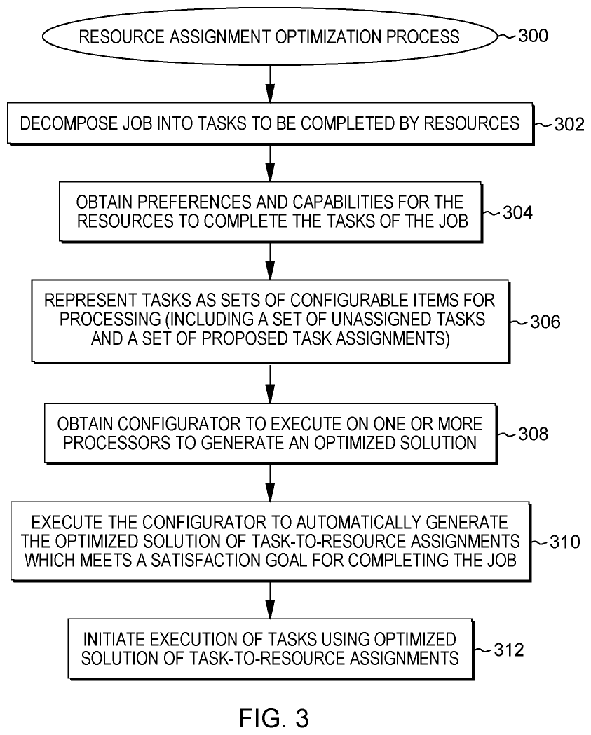

By way of example, one or more embodiments of a resource assignment optimization module and process are described initially with reference to FIGS. 2-3. FIG. 2 depicts one embodiment of a resource assignment optimization module 200 that includes code or instructions to perform resource assignment optimization processing, in accordance with one or more aspects of the present disclosure, and FIG. 3 depicts one embodiment of a resource assignment optimization process, in accordance with one or more aspects of the present disclosure.

Referring to FIGS. 1-2, resource assignment optimization module 200 includes, in one example, various sub-modules used to perform processing, in accordance with one or more aspects of the present disclosure. The sub-modules are, e.g., computer-readable program code (e.g., instructions) and computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101; processors, such as a processor of processor set 110; and/or processing circuitry, such as processing circuitry of processor set 110, etc.

As noted, FIG. 2 depicts one embodiment of a resource assignment optimization module 200 which, in one or more embodiments, includes, or provides resource assignment optimization processing in accordance with one or more aspects of the present disclosure. In the embodiment of FIG. 2, example sub-modules of resource assignment optimization module 200 include a job decomposition sub-module 202 to decompose a job into tasks to be executed by resources, and a resource preferences and capabilities sub-module 204 to obtain preferences and capabilities for the resources to complete tasks of the job.

In addition, resource assignment optimization module 200 includes, in one or more embodiments, a task representations sub-module 206 to represent the tasks of the job as sets of configurable items for processing by a configurator to execute on one or more processors. The sets of configurable items include, in one or more embodiments, a set of unassigned tasks identifying the tasks of the job to be assigned to the resources, and a set of proposed task assignments identifying one or more tasks of the job with proposed assignments to one or more of the resources, and with preferences and capabilities (or suitabilities) of the one or more resources indicated for completing the respective one or more tasks.

Resource assignment optimization module 200 further includes, in one or more embodiments, an obtain configurator sub-module 208 to obtain a configurator to execute on the one or more processors to generate an optimized solution which identifies for the set of unassigned tasks an optimal set of assigned tasks to the resources based on possible combinations of task-to-resource assignments obtained, at least in part, with reference to the set of proposed task assignments. The optimized solution contains task-to-resource assignments based, at least in part, on the capabilities of the resources (to optimize efficiency and minimize cost of performing the job), while meeting a satisfaction goal for completion of the job based, at least in part, on the preferences of the resources.

Resource assignment optimization module 200 further includes, in one or more embodiments, an execute configurator to generate optimized solution sub-module 210 to automatically generate the optimized solution which identifies for the set of unassigned tasks the optimal set of assigned tasks to the resources, where the optimized solution contains task-to-resource assignments based, at least in part, on the capabilities of the resources, while meeting the satisfaction goal for completion of the job based, at least in part, on the preferences of the resources. In one or more embodiments, the resource assignment optimization module 200 also includes an initiate task execution using optimized solution sub-module 212 to initiate execution or performance of the tasks to complete the job in accordance with the optimized solution generated by the configurator.

Advantageously, resource assignment optimization module processing such as disclosed herein facilitates, in one or more embodiments, processing by, for instance, providing a more efficient process to automatically generating by a configurator an optimized solution which identifies an optimal set of task-to-resource assignments, where the optimized solution contains task-to-resource assignments based, at least in part, on the capabilities of the resources (to optimize efficiency and minimize cost), while meeting a satisfaction goal for completion of the job based, at least in part, on the preferences of the resources (to improve resource and/or resource user satisfaction in executing the job). For instance, in one or more embodiments, the satisfaction goal can be to optimize preference realizations for the resources. The resource assignment optimization process can be used in a variety of applications, including, for instance, in assigning a processing job within a computing environment, such as a processing job in a data center environment, or in assigning software development work (such as in crowd-sourcing of software development work in an open source software development environment), or in a manufacturing floor or production environment in assigning tasks to resources for competition of a job, etc.

Note that although various sub-modules are described herein, resource assignment optimization module processing, such as disclosed can use, or include, additional, fewer, and/or different sub-modules. A particular sub-module can include additional code, including code of other sub-modules, or less code. Further, additional and/or other sub-modules can be used. Many variations are possible.

In one or more embodiments, the sub-modules are used, in accordance with one or more aspects of the present disclosure, to perform resource assignment optimization processing. FIG. 3 depicts one example of a resource assignment optimization process, such as disclosed herein. The process is executed, in one or more examples, by a computer (e.g., computer 101 (FIG. 1)), and/or a processor or processing circuitry (e.g., of processor set 110 of FIG. 1). In one example, code or instructions implementing the process, are part of a module, such as resource assignment optimization module 200. In other examples, the code can be included in one or more other modules and/or in one or more sub-modules of the one or more other modules. Various options are available.

As one example, resource assignment optimization process 300 executing on a computer (e.g., computer 101 of FIG. 1), a processor (e.g., a processor of processor set 110 of FIG. 1), and/or processing circuitry (e.g., processing circuitry of processor set 110), decomposes a job into tasks to be completed by resources 302 and obtains performance and capabilities for the resources to complete the tasks of the job 304. In one or more embodiments, resource assignment optimization process 300 further includes representing the tasks as sets of configurable items for processing by a configurator to execute on one or more processors. The sets of configurable items include, in one or more embodiments, a set of unassigned tasks identifying the tasks of the job to be assigned to the resources, and a set of proposed task assignments identifying one or more tasks of the job with proposed assignments to one or more of the resources, and with preferences and capabilities of the one or more resources identified for completing the one or more respective tasks. In addition, in one or more embodiments, resource assignment optimization process 300 includes obtaining a configurator to execute on one or more processors to generate an optimized solution 308. The optimized solution identifies for the set of unassigned tasks an optimal set of assigned tasks to the resources based on possible combinations of task-to-resource assignments obtained, at least in part, with reference to the set of proposed task assignments, where the optimized solution contains task-to-resource assignments based, at least in part, on the capabilities of the resources, while meeting a satisfaction goal for completion of the job based, at least in part, on the preferences of the resources. Note that, in one embodiment, the satisfaction goal can be, for instance, to account for resource, and/or resource-related, preferences in arriving at the optimized solution.

Further, in one or more embodiments, resource assignment optimization process 300 includes executing the configurator to automatically generate the optimized solution which identifies for the set of unassigned tasks the optimal set of assigned tasks to the resources, where the optimized solution contains the task-to-resource assignments based, at least in part, on the capabilities of the resources, while meeting the satisfaction goal for completion of the job based, at least in part, on the preferences of the resources 310. For instance, in one or more embodiments, the satisfaction goal can be to optimize preference realizations for the resources. In one or more embodiments, the resource assignment optimization process 300 further includes initiating execution of the tasks using the optimized solution 312.

The desirability of executing a configurator to enhance task-to-resource assignments can occur in a variety of environments, such as a variety of computer processing environments, technology development environments (including software development environments), production environments, etc. For instance, in one or more environments, a job with tasks to be assigned can be, for instance, a job to be allocated to computing resources (such as data center computing resources), a manufacturing or production job, a software development job, etc. In each case, a resource assignment optimization workflow such as disclosed herein can be utilized to, for instance, achieve a satisfaction goal for completion of the job based, at least in part, on preferences of the resources, while also improving or optimizing efficiency based, for instance, on capabilities of the resources.

For instance, in a typical data center, resources such as computer storage, core processors, memory, network capabilities, and other computing resources or tools, are provisioned or allocated based on different users' requirements for one or more jobs, as well as the quality of service (QOS) desired and based on any service level agreements (SLAs). Typically, this is accomplished by consideration of the capabilities of the resources, computing power needed, etc., to optimize processing efficiency. In this context, user preferences for particular computing resources are typically not considered. Also, a data center controller's assessment and/or preferences for performance of a particular job or task are typically not taken into account. In one or more embodiments, the preferences can be in terms of the different types of resources (e.g., types of storage, types of computing processor, types of memory) to be used in performing a particular job. As described herein, the resource preferences can be modeled and used as part of a configurator workflow in determining the optimal solution for performing the job, and thereby achieve a satisfaction goal for completion of the job based on the resource preferences, such as, for instance, optimizing preference realizations for the resources.

As another example, in a manufacturing or production environment, the manufacturing floor can contain a variety of resources used in producing one or more types of products. Constraints can include machine and/or operator availabilities, as well as capabilities, or skills. In addition, the types of products to be manufactured can be time-windowed, for instance, based on order status and delivery schedules. Operators can be trained to work on certain types of machines, that is, there may be a mapping of skills and capabilities to machines, and the operators can have preferences to work on certain types of tasks, with each task having a duration, and with a production manager or scheduler having a confidence level on reliability of a machine and capability of an operator. Within this environment, in one or more embodiments, a configurator workflow is presented herein for generating an optimized solution which identifies, for a set of unassigned tasks, the optimal set of assigned tasks to the resources based on possible combinations of task-to-resource assignments obtained, at least in part, with reference to a set of proposed task assignments. The optimized solution contains task-to-resource assignments based, at least in part, on the capabilities of the resources, while meeting a satisfaction goal for completion of the job based, at least in part, on the preferences of the resources.

In another embodiment, the job can be, for instance, a software development project, such as a crowd-sourced, open source software development project. Within this context, tasks to be completed can be time-windowed, for instance, based on a workflow for completing the development project, and the resources can include software developers who have certain preferences and capabilities or skills to perform the different tasks. In one or more embodiments, self-assessments can be received or obtained from the software developers to assist the configurator with optimizing the development project. The self-assessments can include preferences, as well as skills and capabilities of the particular developers. As with the above-noted examples, the resource assignment optimization process disclosed herein includes obtaining a configurator to execute on one or more processors to generate an optimized solution which identifies for the set of unassigned tasks an optimal set of assigned tasks to the resources based on possible combinations of task-to-resource assignments obtained, and executing the configurator on the one or more processors to automatically generate the optimized solution, where the optimized solution contains the task-to-resource assignments based, at least in part, on the capabilities of the resources, while meeting a satisfaction goal for completion of the job based, at least in part, on the preferences of the resources.

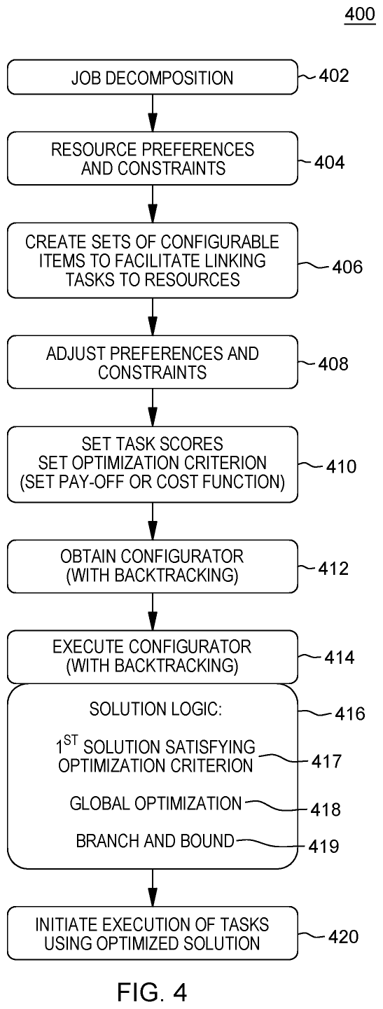

FIG. 4 depicts a further embodiment of a resource assignment optimization process or workflow, generally denoted 400, in accordance with one or more aspects of the present disclosure. In one or more embodiments, resource assignment optimization process 400 is similar to resource assignment optimization process 300 described above in connection with FIG. 3. As illustrated, resource assignment optimization process 400 includes decomposing a job into tasks to be completed by resources 402, and obtaining preferences and capabilities (and/or constraints) for the resources to complete the tasks of the job 404. For instance, decomposing the job into tasks can include decomposing the job into individual tasks that can be carried out by the different resources to complete the job. As part of this, any constraints for related tasks can be added for consideration. Obtaining preferences and capabilities for the resources to complete the tasks can include, for instance, receiving the preferences and capabilities for the resources to complete the tasks from one or more devices within a computing environment implementing the resource assignment optimization workflow. These preferences and capabilities for the resources are used, in one or more embodiments, by a configurator in generating a set of proposed task assignments, such as described herein. Note that, as used herein, the configurator (or optimizer) is, or includes, software or program code to determine an optimized configuration of the task-to-resource assignments, such as disclosed herein.

Resource assignment optimization workflow 400 further includes creating or representing the tasks as sets of configurable items for processing by the configurator to execute on the one or more processors 406. The sets of configurable items are used in linking the tasks to the resources. For instance, in one or more embodiments, the sets of configurable items include a set of unassigned tasks identifying each of the tasks of the job to be assigned to the resources, as well as a set of proposed task assignments identifying one or more tasks of the job with proposed assignments to one or more of the resources, and with preferences and capabilities of the one or more resources identified for completing the one or more respective tasks. By way of example, the tasks can be represented as sets of configurable items for processing by the configurator, which can include attributes for the task representations. The items or task representations can include, for instance, a task type (t), a task duration (d), a resource for the task (a), a resource preference for the task (p), and a suitability of the resource to the task(s).

For instance, in one or more embodiments, task representations of the set of unassigned tasks can each have identified values for the task type (t) and the task duration (d), and undetermined values initially for the resource for the task (a), the resource preference for the task (p), and the suitability of the resource to the task(s), while task representations of the set of proposed task assignments can each have identified values for the task type (t), task duration (d), the resource for the task (a), the resource preference for the task (p), and the suitability of the resource to the task(s). With this information, the configurator is programmed to automatically generate an optimized solution which identifies for the set of unassigned tasks an optimal set of assigned tasks to the resources based on possible combinations of task-to-resource assignments obtained, at least in part, with reference to the set of proposed task assignments. Advantageously, the optimized solution thus contains task-to-resource assignments based, at least in part, on the capabilities of the resources, while also meeting a goal to enhance satisfaction in completing the job based, at least in part, on selecting the solution based on the preferences of the resources for the different tasks of the job.

As part of the process of representing tasks as sets of configurable items, any time intervals for completion of the tasks can be adjusted such that each task/resource interval is independent or non-overlapping of multiple different time intervals. This is to facilitate processing by the configurator of the sets of items in generating the optimized solution. For instance, in one or more embodiments, representing the tasks as sets of configurable items for processing by the configurator can include splitting any unassigned task in the set of unassigned tasks extending across multiple defined time intervals into separate unassigned task representations with non-overlapping time intervals, and splitting any proposed task assignment in the set of proposed task assignments extending across multiple time intervals into separate representations of proposed task assignments with non-overlapping time intervals.

As illustrated in FIG. 4, resource assignment optimization process 400 further includes, in one or more embodiments, adjusting one or more preferences or capabilities (and/or constraints) 408 to, for instance, ensure that a valid solution for optimizing performance of the job exists. For instance, in one or more embodiments, each task needs to have at least one possible resource to complete the task. In an embodiment, one or more preferences can therefore be adjusted to force certain resources to perform certain of the tasks to be assigned, thereby adjusting (e.g., adding to) the set of proposed task assignments. The particular entity making the adjustments to the resource preferences and capabilities can depend on the application of the resource assignment optimization process. For example, in one embodiment, the adjustments to preferences and/or capabilities can be performed by an operator or manager overseeing performance of the job. For instance, in one embodiment, an operator or manager can add certain constraints to ensure quality of a project, or to steer the project in a certain direction. Further, priorities can also be added to ensure reaching a satisfaction goal for completion of the job. For example, to achieve preference priority, candidate resources can be sorted in descending order of resource preference for the task (p). In another example, suitability for a task can be ensured by defining a constraint that the resource(s) have sufficient suitability to perform the task(s), but also to not use up higher-level resources than needed to perform the task. Setting the correct levels of priorities can assist with obtaining a desired optimized solution quickly, thereby speeding up processing of the configurator when executing on the one or more processors.

Resource assignment optimization process 400 of FIG. 4 further includes, in one or more embodiments, setting task scores, optimization criteria, and/or payoff or a cost function, for use by the configurator in automatically generating the optimized solution with an identified optimal set of assignment task(s) to resource(s), based on the possible combinations of task-to-resource assignments 410. For instance, depending on the particular goal of the optimizer, proper measurement of scores can be set, or reversely, cost limits can be set. The optimization can then be carried out with reference to the set scores or optimization criteria. For instance, in one or more embodiments, scores (or optimization criteria) are provided to evaluate a particular solution generated by the configurator. That is, to evaluate or measure a solution consisting of a set of assigned tasks (AT), where the solution can be scored. For instance, in one or more embodiments, a preference score can be defined as a summation of preference values for all assigned tasks of a solution. As described herein, an assigned task of a solution can be obtained for each unassigned task in the set of unassigned tasks (UT) using, at least in part, the set of proposed task assignments (PT), with the configurator selecting a particular proposed task assignment for use as part of the set of assigned tasks generated. In particular, in one embodiment, a preference score can be defined as P_score=SUM (p)×(d) over all assigned tasks in the generated solution, where p is resource preference for the task and d is task duration. In one or more embodiments, this preference score becomes the criteria for maximizing the overall score. In another example, a suitability score (or skill score) can be defined as a summation of suitability values(s) of all assigned tasks in the solution. That is, S_score=SUM(s)×(d) can be determined over all assigned tasks in the solution, where s is the sutiability of the resources to the task and d is the task duration. Other scores can be defined as desired for a particular application of the resource assignment optimization process. For instance, a co-location_score, or a balance_score, etc., can be defined. From the determined scores, then a total score can be ascertained. For example, in one embodiment, total_score=P_score+2× S_score. Note that this is one example only of determining a total score. Other approaches to combining a preference score and suitability score, etc., can be used as desired to emphasize different aspects of a solution. For instance, in another example, S_score/P_score can be used as a factor in determining a total score, if desired.

Resource assignment optimization process 400 further includes obtaining a configurator with backtracking capability to execute on one or more processors to generate an optimized solution 412. The optimized solution identifies for the set of unassigned tasks (UT) an optimal set of assigned tasks (AT) to the resources based on possible combinations of task-to-resource assignments obtained, at least in part in part, with reference to the set of proposed task assignments (PT). The optimized solution is to contain task-to-resource assignments based, at least in part, on the capabilities of the resources, while meeting a satisfaction goal for completion of the job based, at least in part, on the preferences of the resources p.

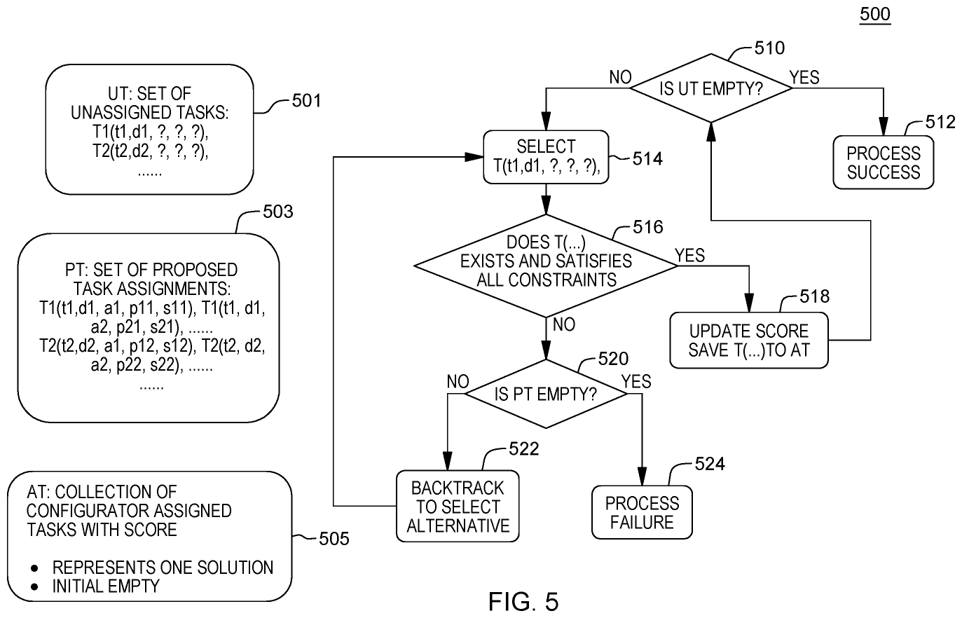

Resource assignment optimization process 400 further includes executing the configurator on one or more processors to automatically generate the optimized solution for performance of the job by the resources 414. As discussed further below with reference to FIG. 5, the configurator includes backtracking, in one or more embodiments, and can implement any of a variety of solution logic approaches 416, including, for instance, one or more of a first solution-satisfying an optimization criteria 417, a global optimization process 418, a branch-and-bound process 419, etc. As described herein, the configurator generates as the optimized solution an optimal set of assigned tasks to resources based on task assignment scores and optimization criteria set for the process. In one or more embodiments, the optimized solution identifies an optimal set of assigned tasks to the resources based on possible combinations of task-to-resource assignments obtained, at least in part, with reference to the set of proposed task assignments (PT). The optimized solution contains task-to-resource assignments based, at least in part, on the capabilities of the resources, while meeting a satisfaction goal for completion of the job based, at least in part, on the preferences of the resources. In this manner, the optimized solution optimizes a satisfaction goal for completion of the tasks of the job based, at least in part, on preferences of the resources, while also improving and/or achieving a desired efficiency for completing the job based, for instance, on capabilities of the resources.

In one or more embodiments, resource assignment optimization process 400 further includes initiating execution of the tasks using the optimized solution 420. In this regard, note that in certain applications, the resource assignment optimization process may fail to identify a valid solution such that there is, for instance, an unassigned task in the set of unassigned tasks with no proposed resource to perform the task. In such a case, an operator, manager or user can add a proposed task assignment to the set of proposed task assignments (PT) to cover the unassigned task(s). For instance, in performing the adjust preferences and constraints process 408, one or more fallback proposed task assignments can be added, which may, for instance, have a low priority, no need to consider optimization, and/or satisfy all constraints to form a valid solution. Resource assignment optimization process 400 can produce an optimized solution with or without using such fallback proposed task assignments. However, existence of fallback proposed task assignments can guarantee that the resource assignment optimization process produces at least one valid solution. In one or more embodiments, the addition of fallback proposed task assignments can be done iteratively, for instance, one or more such assignments can be added after the configurator process fails to produce a valid solution.

As described herein, a configurator is provided and executed to select or identify an optimized solution which identifies for the set of unassigned tasks (UT) an optimal set of assigned tasks (AT) to the resources based on possible combinations of task-to-resource assignments obtained, at least in part, with reference to the set of proposed task assignments (PT). For instance, multiple sets of configurable items can be defined or obtained for the configurator, as discussed herein.

In one or more embodiments, the set of unassigned tasks (UT) includes each task of the job to be assigned to a resource, where the tasks can be defined or identified as described herein. The set of proposed tasks (PT) includes proposed task assignments obtained, for instance, with reference to preferences and capabilities for resources to complete tasks of the job. For instance, in one or more embodiments, the proposed task assignments are created or otherwise obtained based on the preferences and capabilities assigned for the resources, with multiple proposed task assignments being possible for a single unassigned task. The collection of assigned tasks (AT) with score represents one optimized solution obtained by the configurator, and the collection of solutions (ATC) contains the collection of optimized solutions identified by the configurator. A stack of choice points can also be used, in one or more embodiments, to backtrack processing of the configurator. Thus, in one or more embodiments, the items to be used by configurator can include:
UT: Set of Unassigned Tasks:
   T1 (t1, d1,?,?,?),
   T2 (t2, d2,?,?,?)
PT Set of Proposed Tasks:
   T1 (t1, d1, a1, p11, s11), T1 (t1, d1, a2, p21, s21), . . . .
   T2 (t2, d3, a1, p12, s12), T2 (t2, d2, a2, p22, s22), . . . .
AT: Collection of Assigned Tasks with Score
   Represents one solution
      Initial empty
ATC: Collection of Assigned Task Solutions (ATSs)
   Initial empty
CS: Stack of Choice Points:
   Initial empty
Score: initially 0, updated through configuration process
Log: a log file or other method records entire process, useful case of in failure.

In general, the principle of a configurator with backtrack capability can be expressed as:
Task:
   Evaluate constraints
   Find resources to satisfy the this task
   If success:
      Update resource pool
      Update parameters may affect future constraints
      Go to next task
   If fail
      Reset resource pool to the same as when entering this task
      Reset parameters to the same as when entering this task
      Backtrack, try alternative task.

In one or more embodiments, the configurator code can be, or implement, the following routine, which is also illustrated in the process flow of FIG. 5.

| | |
|---|---|
| Begin <main routine>: | |
| Is UT empty? | (1) |
| Yes | |
| <subroutine> Process success | |
| No | |
| Pickup one T(t, d, ?, ?, ?) from UT | |
| Select T (t, d, a, p, s) from PT | |
| Save information in CS stack as a choice point | (2) |
| Is T(t, d, a, p, S) exist and T(t, d, a, p, s) satisfies all constraints? | |
| Yes | |
| Update Score | |
| Save T(t, d, a, p, s) to AT | |
| Goto (1) | |
| No | |
| Backtrack to most recently pushed choice point in CS (i.e., undo | |
| everything between now and the previously choice point). | |
| Is PT empty? | |
| Yes | |
| <subroutine> process failure | |
| No | |
| Select an alternative T(t, d, a′, p′, s′) from PT | |
| Goto (2) | |
| End; | |

As noted, FIG. 5 depicts one embodiment of configurator processing 500, in accordance with one or more aspects of the present disclosure. The processing utilizes, in one or more embodiments, the above-noted set of unassigned tasks (UT) 501, set of proposed tasks (PT) 503, and in operation, fills in the collection of assigned tasks with score representative of one possible solution (AT) 505. In one or more embodiments, the collection of assigned task solutions (ATCs), stack of choice points (CS), Score and Log, as defined above, can also be utilized by the configurator processing, in one or more implementations.

In one or more embodiments, configurator processing 500 determines whether the set of unassigned tasks (UT) is empty 510, and if “yes”, then the process has successfully completed 512. Assuming that there is an unassigned task in the set of unassigned tasks (UT), then an unassigned task (T(t1, d1,?,?,?)) is selected 514. Configurator processing 500 chooses a proposed task assignment (e.g., T (t1, d1, a1, p11, s11) in the set of proposed task assignments (PT) such that all constraints are satisfied 516. Note in this regard, that there can be more than one proposed task assignment that exists and satisfies the constraints for a particular unassigned task. In choosing one of the proposed task assignments, the configurator's action is considered a choice point, which is recorded in the choice point stack (CS). There is a score associated with this proposed task assignment (T(t1, d1, a1, p11, s11)), and so the total score is updated and the task assignment is moved to the set of assigned tasks 518. The process repeats until the set of unassigned tasks (UT) is empty, at which point, successful processing is completed 512.

Should configurator processing 500 determine that there is no proposed task assignment available that satisfies all the constraints 516 for a particular unassigned task (T(t1, d1,?,?,?)), then the configurator determines whether the set of proposed tasks (PT) is empty 520, and if not, the configurator backtracks to a previous choice point 522 to make an alternative selection, and then continue. If there is no previous choice point, or the set of proposed tasks (PT) is empty, then the process has failed 524. No existing proposed task assignment meeting the constraints of a particular unassigned task could result, for instance, from one or more higher-skilled resources having been over-assigned earlier in the process, where a subsequent, unassigned task needs the higher skilled resource, which is no longer available.

In the case of process failure 524, the configurator processing has exhausted all possible combination of choices, but still not been able to produce a valid solution. In this case, a user, operator, etc., can analyze the Log of the configurator process, and determine what happened, and how to make changes to the initial set of unassigned tasks (UT), or the set of proposed task assignments (PT), or to modify one or more constraints, and to then have the configurator repeat the process.

In the case where the configurator process has successfully completed processing 512, a valid solution has been found. Success can be achieved in a variety of manners, depending on the application. For instance, depending on the solution logic being employed by the configurator, the configurator can reach an acceptable or optimized solution. By way of example only, the solution logic can be, or include:
1) If any one solution is acceptable:
   Accept this solution and stop.
2) If predefined Score S_accept needs to be satisfied:
   Is Score≥ S_accept?
      Yes
         Accept this solution and stop.
      No
         Save this solution to ATC collection
         Force failure, trigger backtrack to find alternative solutions.
3) If total optimization required:
   Save this solution to ATC collection
   Force failure, trigger backtrack to find alternative solutions.
   When all possible solutions are found, select the one with the best score.

Since total optimization is computationally costly, the configurator can further include in that case a branch-and-bound process, such as:

```
Branch-and-Bound
  Before running configurator:
    Calculate possible maximum scores of each T(t, d, ?, ?, ?)
  During configuration:
    Estimate possible max score at the end by:
      Sp = current Score + Sum(possible max score of rest of T(t, d, ?, ?, ?))
      If we already had a valid solution with score Sm:
        If this score Sp ≤ Sm:
          Stop, force failure, seeking alternative
        Else:
          Continue
          If reached <subroutine> Process Success
            Save current solution and score as Sm.
```

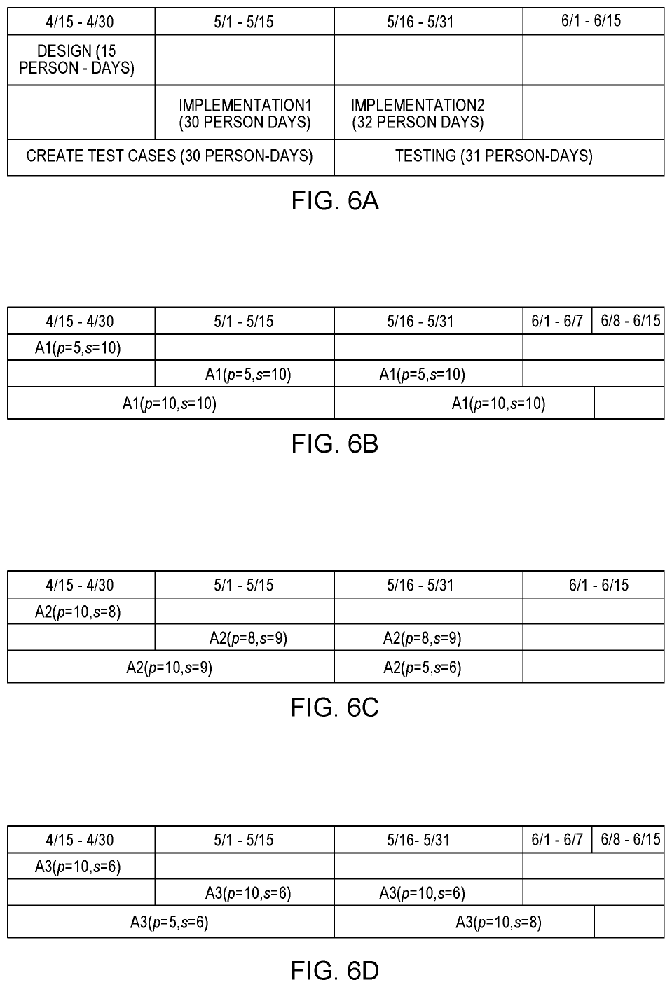

As a specific example, assume that the resource assignment optimization process is to optimize a software development job, where the resources are computing system resources and/or software developer resources. In such a case, the software development job can be decomposed into multiple tasks to be completed for the job. For instance, the job can be decomposed into a software development schedule with different time intervals as indicated in FIG. 6A.

In addition to the schedule, assume the following constraints:
Implementation1: requires Design done.
Implementation2: requires Implementation1 done.
Test: requires Create test case done.
Test: requires Implementation1 done.

In one or more embodiments, preferences and capabilities of the resources to execute the software development job are obtained, including preferences and capabilities of the software developers, which in one or more embodiments can be provided by the developers themselves as input to the resource assignment optimization process. For instance, assume (in one example) that there are three software developers, A1, A2, A3, each with respective preferences and efficiencies.

For instance, software developer A1 may have preferences and efficiencies as indicated in FIG. 6B, with the following constraints:
A1 will take a short vacation near end of the project.
A1 prefers Test case creation and Test, and less prefers design and implementation.
A1 is skilled at all tasks.

Software developer A2 may have preferences and efficiencies as indicated in FIG. 6C, with the following constraints:
A2 will take a two-week vacation in June.
A2 prefers design and implementation equally, over test case creation and testing.
A2 gives estimations of skill(s) to each type of task, based on experience and recent learning.

Software developer A3 may have preferences and efficiencies as indicated in FIG. 6D, with the following constraints:
A3 will take a short vacation near end of the project.
A3 prefers design, implementation or testing. Less prefers test case creation.
A3 gives estimations of skill(s) to each type of task, based on experience and recent learning.

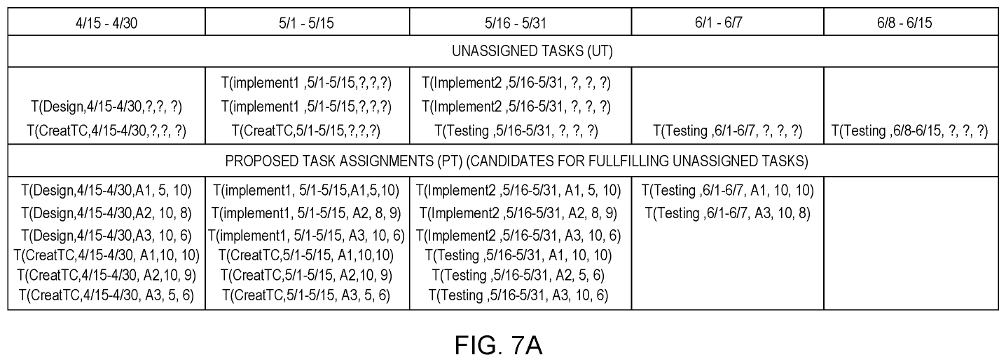

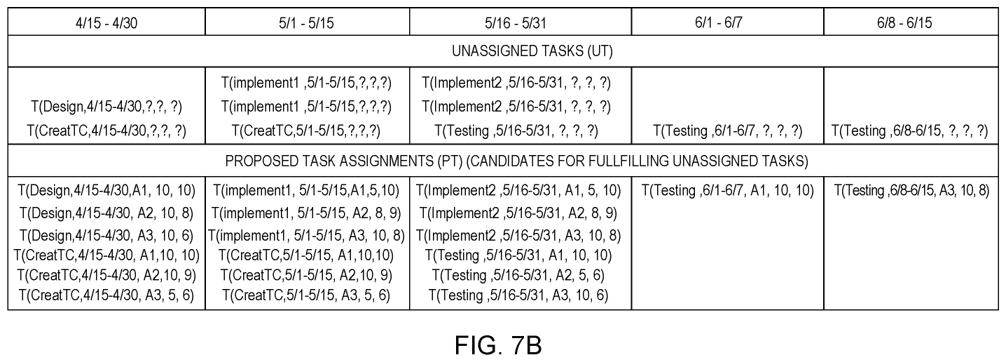

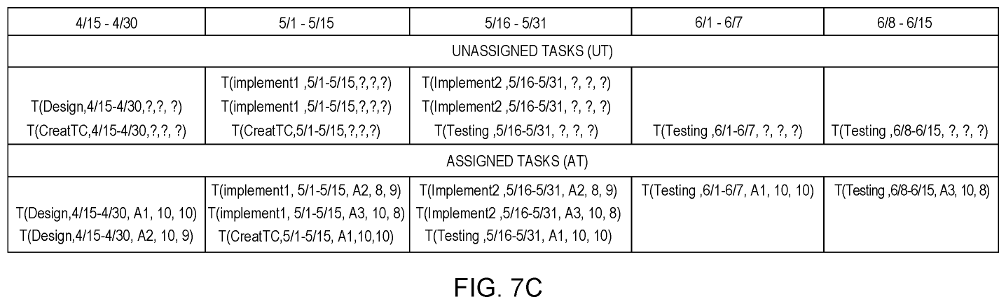

The above-noted preferences and capabilities (or constraints) can be expressed as configurable items or task representations, such as described above, where each unassigned task (UT) is defined as T (t, d,?,?,?), and each proposed task assignment in the set of proposed task assignments (PT) is defined as T (t, d, a, p, s), where, in one embodiment, the resource for the task a can be the particular software developer A1, A2, A3, in this example. In order to facilitate configurator processing, any tasks in the unassigned tasks or the proposed task assignments that overlap multiple defined time intervals, are separated into separate tasks, either separate unassigned tasks or separate proposed task assignments. For instance, in one embodiment, the beginning and ending dates of each date interval can be set out in ascending order: d1, d2, d3, d4, . . . dn. In the example of FIG. 6A, these dates are listed as 4/15, 4/30, 5/1, 5/15, 5/16, 5/31, 6/1, 6/7, 6/8, 6/15. Thus, the intervals to be used by the configurator processing can be expressed as [4/15, 4/30], [5/1, 5/16] . . . [6/1, 6/7], [6/8, 6/15]. For instance, unassigned tasks T (testing, 5/15-6/15,?,?,?) needs to be split into three different unassigned tasks in three different intervals, that is, T (testing, 5/15-5/31,?,?,?), T (testing 6/1-6/7,?,?,?), & T (testing, 6/8-6/15,?,?,?). Similarly, software developer A1's proposed task T (testing, 5/15-6/15, A1, 10, 10), is split into T (testing, 5/15-5/31, A1, 10, 10) and T (testing, 6/1-6/7, A1, 10, 10). With task representations such as described herein, and with all data entries being made non-overlapping, the sets of unassigned tasks (UT) and proposed task assignments (PT) are obtained (in one example) as illustrated in FIG. 7A.

In this manner, the corresponding proposed tasks (PT) for a given unassigned task (UT) can be readily identified by the configurator processing. Note that there are two identical T (Implement1, 5/1-5/15,?,?,?) in the set of unassigned tasks (UT). Because each such unassigned task (UT) will be assigned to one developer, a total two such assignments are needed to cover the desired task workload.

In one or more embodiments, a controller (e.g., manager) can adjust the proposed task assignments as submitted by the software developers to, for instance, further ensure coverage. A specific example of this is depicted in FIG. 7B. In this example, it was noted that no software developer volunteered to take the unassigned task (UT) T (Testing, 6/7-6/15,?,?,?). After consulting with A3, it was agreed to change T (Testing, 6/1-6/7, A3, 10, 8) to T (Testing, 6/7-6/15, A3, 10, 8). Assume that the manager wanted A1, who has the highest skill in design, to take the Design, so after discussing with A1, the manager changed T (Design, 4/15-4/30, A1, 5, 10) to T (Design, 4/15-4/30, A1, 10, 10). The manager also considered the indicated skills of the developer team members; and determined that some skills of the team members were higher than the team member estimated, and so, T (Testing, 5/16-5/31, A2, 5, 6) is changed to T (Testing, 5/16-5/31, A2, 5, 8), T (Implement1, 5/1-5/15, A3, 10, 6) to T (Implement1, 5/1-5/15, A3, 10, 8), and T (Implement2, 5/16-5/31, A3, 10, 6) to T (Implement2, 5/16-5/31, A3, 10, 8).

In addition, as noted herein, preferences and constraints can be adjusted, if desired. For instance, assume several constraints are listed initially as:
Perquisition of covering T (Implement1, any-date,?,?,?), is that T (Design, all-dates,?,?,?) has been covered.
Perquisition of covering T (Implement2, any-date,?,?,?), is that T (Implement1, all-dates,?,?,?) has been covered.
Perquisition of covering T (Testing, any-date,?,?,?), is that T (CreateTC, all-dates,?,?,?) has been covered.
Perquisition of covering T (Testing, any-date,?,?,?), is that T (Implement1, all-dates,?,?,?) has been covered.

Constraints can also be added to ensure quality of the project or steer the configurator in a certain direction. For example:
Each type t of task must have at least one assignee with suitability or skill value≥n_t (i.e., for any t, exists s≥n_t, in T (t,d,a,p,s). In order to force the assignment, a manager can adjust the priority and/or adjust the skill level of the chosen resource.

Priorities can also be added or adjusted to facilitate steering the configurator in a certain direction. For instance:
Given an unassigned task (UT), there are typically several proposed tasks (PT) available, and in such cases, priorities can be defined to help determine which one the configurator is to select first. For example:
   Preference priority. It is desired to satisfy a developer's preference if possible. Therefore, the configurator can sort the candidates T (t,d,a,p,s) in descending order of p.
   Just right skill priority (to be used with an at least one assignee with skill≥n_t constraint). For instance, it can be preferred that a developer have a skill high enough for the task, but also not use up highly skilled developers too quickly. In such a case, the configurator can sort candidates T (t,d,a,p,s) in ascending order by this formular: s≥n_t?n_t-s: 100. The result is that the configurator process will prefer the proposed assignment with the smallest skill s but ≥required n_t.

Setting the right priorities can help ensure that configurator processing reaches the desired solution quickly, greatly speed up the configuration process.

In one exemplary embodiment, the configurator process can produce an optimized solution (AT), such as illustrated in FIG. 7C, and where scoring can be determined as follows:

$$Skill score : S\_score = 10 ⋆ 16 + 9 ⋆ 16 + 9 ⋆ 15 + 8 ⋆ 15 + 10 ⋆ 15 + 9 ⋆ 16 + 8 ⋆ 16 + 10 ⋆ 16 + 10 ⋆ 7 + 8 ⋆ 8 = 1275$$

$$Preference score : P\_score = 10 ⋆ 16 + 10 ⋆ 15 + 8 ⋆ 15 + 10 ⋆ 15 + 10 ⋆ 15 + 8 ⋆ 16 + 10 ⋆ 16 + 10 ⋆ 16 + 10 ⋆ 7 + 10 ⋆ 8 = 1328$$

$$Combined score : Total\_score = 2 ⋆ E + P = 2 ⋆ 1275 + 1328 = 3878.$$

Note from this solution that:
The manager's mandate is realized, A1 is assigned to the design task, overriding the preferences of A1.
A2's wish to take days off is granted.
A1's preference of testing assignment is satisfied.
A3's preference of development assignment is satisfied.
High skill and preference scores are achieved.

Those skilled in the art will note from the above description that, provided herein are computer-implemented methods, computer systems and computer program products which provide configurator-based generation of an optimized task-to-resource assignment solution that is based, at least in part, on the capabilities of the resources, while meeting a satisfaction goal for completion of the job based, at least in part, on preferences of the resources. In one or more embodiments, this is accomplished by decomposing a job into tasks, and in particular, into non-overlapping time-interval tasks with respective task representations including, for instance, a task type, and a task duration. Preferences for the resources to be used in performing the tasks are obtained. In addition, capabilities (or suitability) of the resources to complete the tasks of the job are obtained. A configurator is obtained to execute on one or more processors and generate an optimized solution which identifies for a set of unassigned tasks an optimal set of assigned tasks to resources based on possible combinations of task-to-resource assignments obtained, at least in part, with reference to a set of proposed task assignments. The optimized solution contains task-to-resource assignments based, at least in part, on the capabilities of the resources, while meeting a satisfaction goal for completion of the job based, at least in part, on the preferences of the resources. The configurator can be programmed or configured to determine, for instance, a satisfaction score and an efficiency score for a particular set of task-to-resource assignments (AT). In one or more embodiments, the configurator executes on one or more processors to automatically generate the optimized solution which identifies for the set of unassigned tasks the optimal set of assigned tasks to the resources, where the optimized solution contains the task-to-resource assignments based, at least in part, on the capabilities or suitabilities of the resources, while meeting a satisfaction goal for completion of the job based, at least in part, one the preferences of the resources. In one or more embodiments, a branch-and-bound algorithm or process can be used to arrive at the optimal solution to facilitate the searching and computational steps in order to improve efficiency of the configurator. In one or more embodiments, a manager, operator, user, etc., can be provided with one or more control points to facilitate changing or otherwise overriding a specific assignment (e.g., to provide another form of constraint on the configurator).

Advantageously, the resource assignment optimization process disclosed herein can provides, in one or more embodiments, an optimized solution containing a set of task-to-resource assignments that safeguards fulfillment of one or more goals. Since resources have associated preferences, the resources can be better able to process the tasks assigned, which improves execution of the job. In one or more embodiments, a manager, operator, controller, user, etc., can set one or more optimization criteria, and the configurator can execute to produce the optimized solution based on the criteria. Advantageously, the configurator can be executed multiple times, including during performance of the job against any remaining task, in order to dynamically improve on the execution of the job.

The terminology used herein is for the purpose of describing particular embodiments only and is not intended to be limiting of the disclosure. As used herein, the singular forms “a”, “and” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
obtaining, by one or more processors, preferences and capabilities for resources to complete tasks of a job;
representing the tasks as sets of configurable items, the sets of configurable items including a set of unassigned tasks identifying the tasks of the job to be assigned to the resources and a set of proposed task assignments identifying one or more tasks of the job with proposed assignment to one or more of the resources, and with preferences and capabilities of the one or more resources indicated for completing the one or more tasks;
obtaining a configurator to execute on the one or more processors to generate an optimized solution which identifies for the set of unassigned tasks an optimal set of assigned tasks to the resources based on possible combinations of task-to-resource assignments obtained, at least in part, with reference to the set of proposed task assignments, where the optimized solution contains task-to-resources assignments based, at least in part, on the capabilities of the resources, while meeting a satisfaction goal for completion of the job based, at least in part, on the preferences of the resources; and
executing the configurator on the one or more processors to automatically generate the optimized solution which identifies for the set of unassigned tasks the optimal set of assigned tasks to the resources, wherein the optimized solution contains the task-to-resource assignments based, at least in part, on the capabilities of the resources, while meeting the satisfaction goal for completion of the job based, at least in part, on the preferences of the resources.

2. The computer-implemented method of claim 1, wherein representing the tasks as the sets of configurable items for processing by the configurator to execute on the one or more processors includes defining associated attributes for respective task representations, the associated attributes comprising a task type, a task duration, a resource for the task, a resource preference for the task, and a suitability of the resource to the task.

3. The computer-implemented method of claim 2, wherein respective task representations of the set of unassigned tasks each have identified values for the task type and the task duration, and undetermined values for the resource for the task, the resource preference for the task, and the suitability of the resource to the task.

4. The computer-implemented method of claim 3, wherein respective task representations of the set of proposed task assignments each have identified values for the task type, the task duration, the resource for the task, the resource preference for the task and the suitability of the resource to the task.

5. The computer-implemented method of claim 1, wherein representing the tasks as the sets of configurable items for processing by the configurator includes splitting an unassigned task of the set of unassigned tasks that extends across multiple defined time intervals into separate unassigned tasks with non-overlapping time intervals, and splitting a proposed task assignment of the set of proposed task assignments that extends across multiple defined time intervals into separate proposed task assignments with non-overlapping time intervals.

6. The computer-implemented method of claim 1, further comprising prespecifying a satisfaction score threshold for the optimized solution, and wherein executing the configurator on the one or more processors to automatically generate the optimized solution includes confirming by the configurator that the optimized solution has a satisfaction score associated therewith which at least meets the prespecified satisfaction score threshold.

7. The computer-implemented method of claim 1, further comprising:
prespecifying an efficiency score threshold for the optimized solution, wherein executing the configurator on the one or more processors to automatically generate the optimized solution includes confirming by the configurator that the optimized solution has an efficiency score associated therewith which at least meets the prespecified efficiency score threshold; and
prespecifying a preference score threshold for the optimized solution, wherein executing the configurator on the one or more processors to automatically generate the optimized solution further includes confirming by the configurator that the optimized solution has a preference score threshold associated therewith which at least meets the prespecified preference score threshold.

8. The computer-implemented method of claim 1, wherein the configurator is a branch-and-bound configurator which implements branch-and-bound processing of unassigned tasks of the set of unassigned tasks in determining the optimized solution.

9. The computer-implemented method of claim 1, further comprising initiating execution of the tasks of the job using the optimized solution identifying the optimal set of assigned tasks to resources.

10. A computer system comprising:
a memory; and
at least one processor in communication with the memory, wherein the computer system is configured to perform a method, the method comprising:
obtaining, by one or more processors, preferences and capabilities for resources to complete tasks of a job;
representing the tasks as sets of configurable items, the sets of configurable items including a set of unassigned tasks identifying the tasks of the job to be assigned to the resources and a set of proposed task assignments identifying one or more tasks of the job with proposed assignment to one or more of the resources, and with preferences and capabilities of the one or more resources indicated for completing the one or more tasks;
obtaining a configurator to execute on the one or more processors to generate an optimized solution which identifies for the set of unassigned tasks an optimal set of assigned tasks to the resources based on possible combinations of task-to-resource assignments obtained, at least in part, with reference to the set of proposed task assignments, where the optimized solution contains task-to-resources assignments based, at least in part, on the capabilities of the resources, while meeting a satisfaction goal for completion of the job based, at least in part, on the preferences of the resources; and
executing the configurator on the one or more processors to automatically generate the optimized solution which identifies for the set of unassigned tasks the optimal set of assigned tasks to the resources, wherein the optimized solution contains the task-to-resource assignments based, at least in part, on the capabilities of the resources, while meeting the satisfaction goal for completion of the job based, at least in part, on the preferences of the resources.

11. The computer system of claim 10, wherein representing the tasks as the sets of configurable items for processing by the configurator to execute on the one or more processors includes defining associated attributes for respective task representations, the associated attributes comprising a task type, a task duration, a resource for the task, a resource preference for the task, and a suitability of the resource to the task.

12. The computer system of claim 11, wherein respective task representations of the set of unassigned tasks each have identified values for the task type and the task duration, and undetermined values for the resource for the task, the resource preference for the task, and the suitability of the resource to the task.

13. The computer system of claim 12, wherein respective task representations of the set of proposed task assignments each have identified values for the task type, the task duration, the resource for the task, the resource preference for the task and the suitability of the resource to the task.

14. The computer system of claim 10, wherein representing the tasks as the sets of configurable items for processing by the configurator includes splitting an unassigned task of the set of unassigned tasks that extends across multiple defined time intervals into separate unassigned tasks with non-overlapping time intervals, and splitting a proposed task assignment of the set of proposed task assignments that extends across multiple defined time intervals into separate proposed task assignments with non-overlapping time intervals.

15. The computer system of claim 10, further comprising prespecifying a satisfaction score threshold for the optimized solution, and wherein executing the configurator on the one or more processors to automatically generate the optimized solution includes confirming by the configurator that the optimized solution has a satisfaction score associated therewith which at least meets the prespecified satisfaction score threshold.

16. The computer system of claim 10, further comprising:
prespecifying an efficiency score threshold for the optimized solution, wherein executing the configurator on the one or more processors to automatically generate the optimized solution includes confirming by the configurator that the optimized solution has an efficiency score associated therewith which at least meets the prespecified efficiency score threshold; and
prespecifying a preference score threshold for the optimized solution, wherein executing the configurator on the one or more processors to automatically generate the optimized solution further includes confirming by the configurator that the optimized solution has a preference score threshold associated therewith which at least meets the prespecified preference score threshold.

17. A computer program product comprising:
one or more computer readable storage media and program instructions collectively stored on the one or more computer readable storage media readable by at least one processer to:
obtain, by one or more processors, preferences and capabilities for resources to complete tasks of a job;
represent the tasks as sets of configurable items, the sets of configurable items including a set of unassigned tasks identifying the tasks of the job to be assigned to the resources and a set of proposed task assignments identifying one or more tasks of the job with proposed assignment to one or more of the resources, and with preferences and capabilities of the one or more resources indicated for completing the one or more tasks;
obtain a configurator to execute on the one or more processors to generate an optimized solution which identifies for the set of unassigned tasks an optimal set of assigned tasks to the resources based on possible combinations of task-to-resource assignments obtained, at least in part, with reference to the set of proposed task assignments, where the optimized solution contains task-to-resources assignments based, at least in part, on the capabilities of the resources, while meeting a satisfaction goal for completion of the job based, at least in part, on the preferences of the resources; and
execute the configurator on the one or more processors to automatically generate the optimized solution which identifies for the set of unassigned tasks the optimal set of assigned tasks to the resources, wherein the optimized solution contains the task-to-resource assignments based, at least in part, on the capabilities of the resources, while meeting the satisfaction goal for completion of the job based, at least in part, on the preferences of the resources.

18. The computer program product of claim 17, wherein the program instructions readable by the at least one processing circuit to represent the tasks as the sets of configurable items for processing by the configurator to execute on the one or more processors includes program instructions readable by the at least one processing circuit to define associated attributes for respective task representations, the associated attributes comprising a task type, a task duration, a resource for the task, a resource preference for the task, and a suitability of the resource to the task.

19. The computer program product of claim 18, wherein respective task representations of the set of unassigned tasks each have identified values for the task type and the task duration, and undetermined values for the resource for the task, the resource preference for the task, and the suitability of the resource to the task.

20. The computer program product of claim 19, wherein respective task representations of the set of proposed task assignments each have identified values for the task type, the task duration, the resource for the task, the resource preference for the task and the suitability of the resource to the task.
